(19) United States
(12) Patent Application Publication
(10) Pub. No.: US 2020/0356965 A1
(43) Pub. Date: Nov. 12, 2020

(54) BUNDLED PAYMENT EPISODE ADMINISTRATION USING SMART CONTRACTS AND DISTRIBUTED LEDGER

(71) Applicant: Patientblox, Inc., Alpharetta, GA (US)

(72) Inventors: Rahul Sharma, Cumming, GA (US); Lynn Eliot Carroll, Atlanta, GA (US); Deepti Sharma, Cumming, GA (US); Apoorva Patel, Milton, GA (US); John Kenneth Layne, Marietta, GA (US)

(73) Assignee: Patientblox, Inc., Alpharetta, GA (US)

(21) Appl. No.: 16/868,690

(22) Filed: May 7, 2020

Related U.S. Application Data
(60) Provisional application No. 62/844,527, filed on May 7, 2019.

(51) Int. Cl. G06Q 20/10; G06Q 20/40; G06Q 20/38; H04L 9/06

(52) U.S. Cl. CPC G06Q 20/102; G06Q 20/4016; H04L 2209/56; H04L 9/0637; H04L 2209/38; G06Q 20/3825

(57) ABSTRACT

Payment administration systems and methods. A system includes first and second provider entities, a risk bearing entity, a distributed ledger and a payment manager application. The first provider entity provides at least a first step of the bundled treatment episode. The second provider entity provides at least a second step of the bundled treatment episode. The risk bearing entity approves the bundled treatment episode. The first and second provider entities and the risk bearing entity enter into one or more smart contracts related to payments for the bundled treatment episode. The distributed ledger enforces the one or more smart contracts. The payment manager application uses the distributed ledger technology. Each of the first and second provider entities send claims to the payment manager application. The payment manager application tags the claims as being part of the bundled treatment episode and approves the claims in accordance with the smart contracts.

### CROSS-REFERENCE TO RELATED APPLICATION(S)

This application claims priority to U.S. Provisional Patent Application Ser. No. 62/844,527, filed on May 7, 2019, which is incorporated herein by reference in its entirety.

### TECHNICAL FIELD

The present disclosure relates to payment administration using smart contracts and distributed ledger technology, and more particularly to payment administration for bundled payment scenarios.

### BACKGROUND

The healthcare ecosystem in the United States presents an economic environment that is uniquely complex. The service-to-payment cycle for healthcare service providers is burdened with regulation, multifaceted contractual nuances, third party payers, paper-based processes, and technical system inefficiencies. This setting creates numerous challenges for healthcare service providers, including the management of daily operations and the timing of payment received for services performed.

For example, typically healthcare provider bills a third-party payer, such as a health insurance company, for services that are rendered to a patient. The health insurance company receives the bill and processes the bill to ensure that the services rendered were performed within the guidelines set forth in any contracts between the parties. In some cases, the amount billed may be reduced, denied, or challenged, requiring further information exchange between the parties. Delays of weeks or months are not uncommon from the time a health insurance company receives a bill and pays the health service provider. Conventional systems consider each procedure as an individual, discrete event, and payments and approvals for such procedures are managed one a one-by-one basis. Similar dynamics exist in other industries, including other forms of insurance.

### SUMMARY

In one aspect, payment administration system for administering payments related to a bundled treatment episode involving multiple providers is presented. The system includes first and second provider entities, a risk bearing entity, a distributed ledger and a payment manager application. The first provider entity provides at least a first step of the bundled treatment episode. The second provider entity provides at least a second step of the bundled treatment episode. The risk bearing entity approves the bundled treatment episode. The first and second provider entities and the risk bearing entity enter into one or more smart contracts related to payments for the bundled treatment episode. The distributed ledger enforces the one or more smart contracts. The payment manager application uses the distributed ledger technology. Each of the first and second provider entities send claims to the payment manager application. The payment manager application tags the claims as being part of the bundled treatment episode and approves the claims in accordance with the smart contracts.

In another aspect, a method for administering payments related to a bundled treatment episode involving multiple providers is provided. The method includes the following steps. Initiating a bundled treatment episode. Approving the bundled treatment episode. Establishing one or more smart contracts related to payments for the bundled treatment episode. Providing at least a first step of the bundled treatment episode. Providing at least a second step of the bundled treatment episode. Sending claims related to the first and second steps. Tagging the claims as being part of the bundled treatment episode. Approving the claims in accordance with the smart contracts.

### BRIEF DESCRIPTION OF THE SEVERAL VIEWS OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1 is a flowchart depicting one example of payment administration using smart contracts and distributed ledger technology, in accordance with one or more aspects of the present technique;

FIG. 2 is a flowchart depicting one example of payment administration using smart contracts and distributed ledger technology, in accordance with one or more aspects of the present technique;

FIG. 3 is a flowchart depicting another example of payment administration using smart contracts and distributed ledger technology, in accordance with one or more aspects of the present technique;

FIG. 4 is a flowchart depicting another example of payment administration using smart contracts and distributed ledger technology, in accordance with one or more aspects of the present technique;

FIG. 5 is a flowchart depicting another example of payment administration using smart contracts and distributed ledger technology, in accordance with one or more aspects of the present technique;

FIG. 6 is a flowchart depicting another example of payment administration using smart contracts and distributed ledger technology, in accordance with one or more aspects of the present technique; and

FIGS. 7A & 7B are flowcharts depicting a specific example across multiple entities, in accordance with one or more aspects of the present technique.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The present disclosure relates to bundled payments administration. For instance, bundled payments represent a shift towards value-based reimbursement (i.e. pay for quality/outcomes) from a traditional fee-for-service model (which is volume based). Bundled administration capability of the solution presented herein can be utilized by healthcare organizations, known as Healthcare Payers (Payers), Risk Bearing Entities (RBE) or Participating Providers (PP) and offers an automated workflow for the administration of the contracts. The present solutions provide melding of structured and unstructured data, integration with multiple providers across the continuum of care, and permissioned disclosure of healthcare data.

The present techniques overcome limitations of the prior art, as follows. For example, the techniques allow for reconciling value-based payments in a fee-for-service environment. In addition, a wide variety of quality measures may be tracked. Further, unlike prior art solutions, which have a lack of capabilities to administer bundled episodes and downstream payments to PPs, the present technique is designed to address these challenges in a scalable manner.

In one embodiment, a system is presented that provides an end-to-end complete workflow solution for episodic payment administration. For example, episodic events are tracked in real time using Distributed Ledger Technologies (DLT) and claim tagging process can separate the fee-for-service claims from the Episode-Included claims. Episode definitions are maintained in a Smart Contract Library and care guidelines are incorporated.

By way of explanation, bundled episodes processing includes a claim tagging functionality. The claims tagging functionality is, for instance, a solution that helps to identify whether a claim is a part of bundled payment or fee-for-service. Tagging of the claims (e.g., claims coming from RBE and the different PPs) is part of the workflow. This tagging process helps to identify the right Patient ID & Episode ID across the sets of claims that are processed. One issue that claims tagging helps to resolve is the separation of Bundle Payments (Episodes) claims vs the Fee for Service (FFS) claims and tagging the claims with the right Episode ID. This prevents issues of double payment of the same claim (e.g., as both a FFS claim and a bundle-included claim).

For example, attributes that are used for tagging of claims include: Contract definition (Group ID and Plan Number); Procedure Codes; Diagnosis Codes; NPI#; Member ID; Date of Service (Start and End Dates)

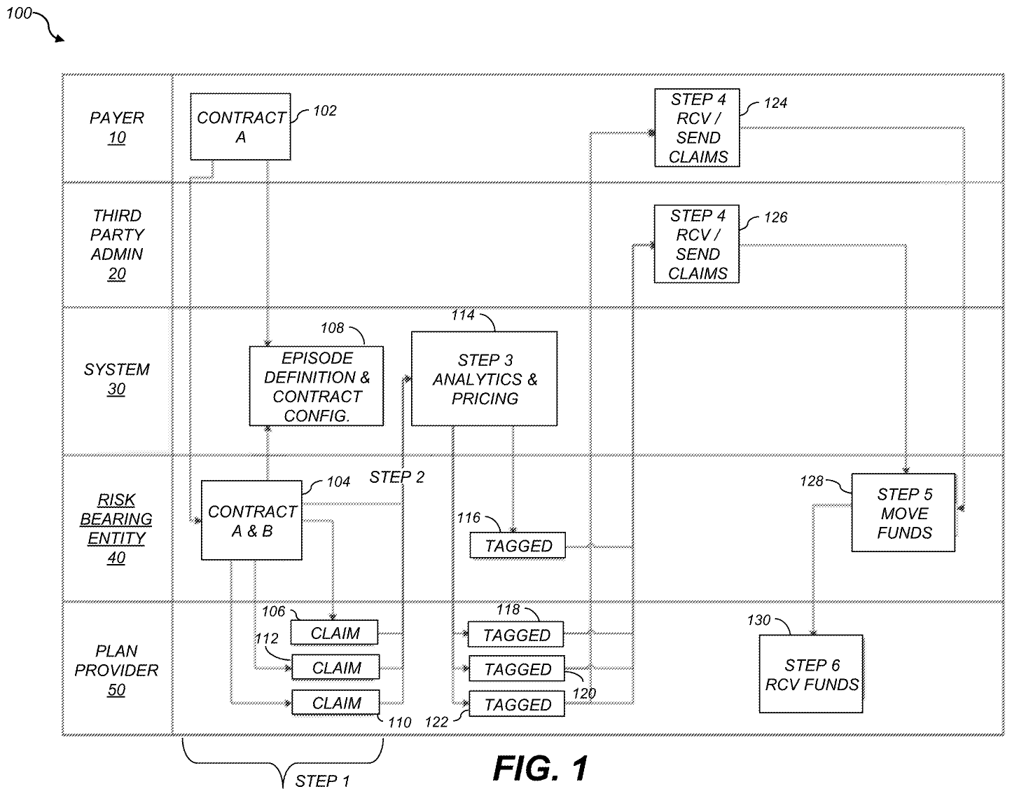

Described with respect to FIGS. 1-7B are six different workflow processes as examples with respect to bundled payment episode scenarios that are in accordance with the techniques set forth herein. In the embodiments of FIGS. 1-6, a number of entities participate in the process. The entities include a payer 10, a third party administrator (TPA) 20, a system 30 of the present disclosure, a risk bearing entity (RBE) 40, a provider 50, and a partner 60. In one or more embodiments, system 30 includes a payment manager application for managing analytics, pricing, tagging, and approval of claims and/or episodes or procedures, and makes use of a distributed ledger, Blockchain, or any other technology to allow for immutable transactions. Actions performed by each of these entities is identified in the workflow examples in a horizontal row to the right of the entity, with connector lines identifying communications between the entities. A person of ordinary skill would understand that each entity may be represented by one or more computers that are in contact with the system of the present disclosure using any appropriate networking technology.

In addition, Smart Contracts that are referenced are described in further detail at the end of this description, and represent immutable contracts between the entities that are written to a distributed ledger using a technology such as Blockchain so that the contracts cannot be modified after creation. In the embodiments described herein, each of the entities can communicate with the system, which can run a payment manager application with a distributed ledger. By communicating with the system, crosswise connections between each entity are reduced or eliminated. For example, if N entities are connected in a mesh network to one another, the number of connections required is on the order of N-squared. But if the entities are connected to a centralized system, only N connections are needed. Thus, the present system serves to establish an “ecosystem” or “marketplace” that in aggregate requires a smaller amount of computer resources than would be required in conventional systems. This reduction in the need for computer resources represents an improvement to the computing resources themselves, and also is a practical application that offers an improvement in the field of medical claims processing. A person of ordinary skill would understand that this is a significant reduction in the required computer resources and a reduction in complexity as compared with the prior art. In addition, conventional distributed ledger technologies, such as Blockchains and other data structures, are very generic and treat all entities in the same manner. The present disclosure imposes a hierarchy of entities that are treated and behave differently, and as such the distributed ledger and Blockchain are themselves modified and improved by these techniques.

FIG. 1 is a flowchart generally depicting a method 100 in which the risk bearing entity 40 and provider 50 send claims to the system 30 for analytics and pricing, the system 30 tags the claims, and the claims are sent to the payer 10 or third party administrator 20. The method 100 includes blocks 102-130, which are organized into a series of operational Steps 1-5.

In the embodiment of FIG. 1, Step 1 includes configuration and definition of Smart Contracts A & B, as follows. The payer 10 at block 102 and the risk bearing entity 40 at block 104 establish Contract A. The risk bearing entity 40 at block 104 and plan provider 50 at block 106 establish Contract B. The system 30 at block 108 configures Contracts A & B and performs episode definition, including establishment of rules.

Step 2 includes claims being sent to the system 30 for analytics and pricing. For instance, the plan provider 50 submits claims relating to Contract B at blocks 106-110.

At Step 3, the system 30 at block 114 performs the analytics and pricing in accordance with Contracts A & B. For example, the system 30 creates a patient roster, analyzes and prices claims, and performs tagging of claims. The system 30 then uses claim tagging capabilities to tag the claims, for example, as Bundled Payment included (BP) or Fee For Service (FFS).

Continuing with the embodiment of FIG. 1, after the system 30 tags the claims, they are sent back to the entities, specifically to the risk bearing entity 40 at block 116 and the provider 50 at blocks 118-122.

At Step 4, after the tagged claims are received by the entities, the risk bearing entity 40 at block 116 and the provider 50 at blocks 118-122 send the claims on to either the payer 10 or the third-party administrator 20. Then, the payer 10 receives tagged claims at block 124 and moves funds to pay the risk bearing entity 40, and/or the third-party administrator 20 receives tagged claims at block 126 and moves funds to pay the risk bearing entity 40.

At Step 5, the risk bearing entity 40 at block 128 receives the funds and moves the funds and the provider 50 at block 130 receives the funds. The funds are received by the provider based on status changes such as progress through an episode that is part of a bundled payment that allows payment based on the status of the episode.

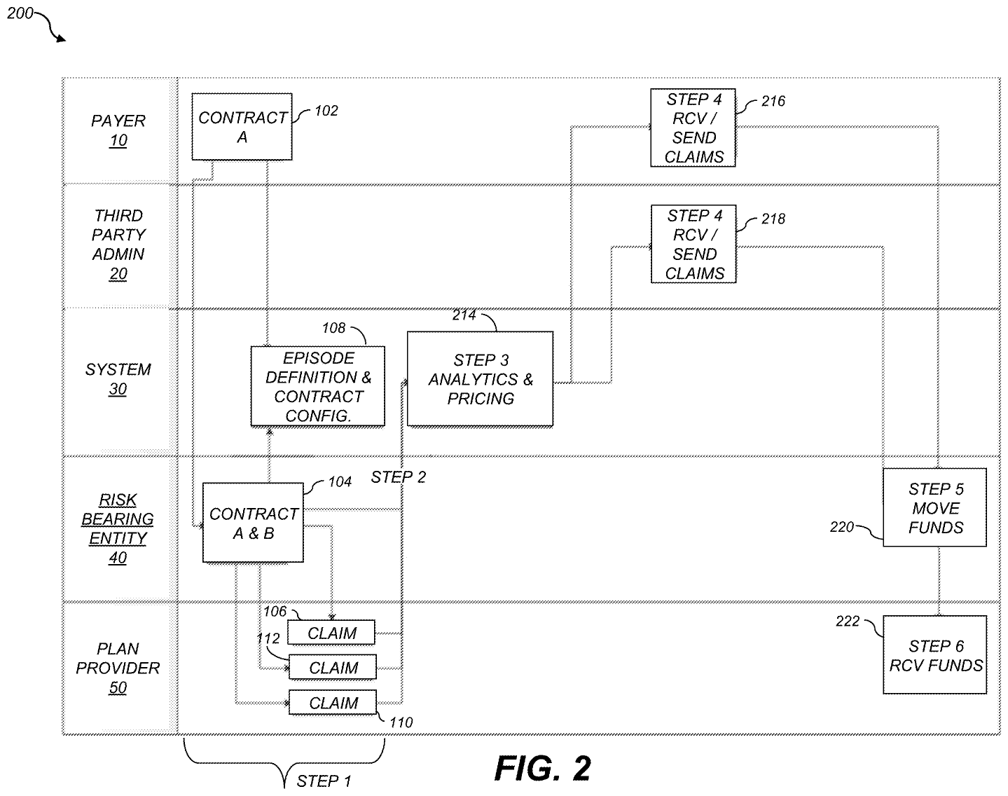

FIG. 2 is a flowchart depicting a method 200 of payments administration using smart contracts and distributed ledger technology. The example of FIG. 2 differs from the example of FIG. 1, in that at Step 3, the system 30 at block 214 sends the tagged claims directly to the payer 10 at block 216 and the third-party administrator 20 at block 218. For instance the risk bearing entity 40 and provider 50 will send to the system 30 (e.g., to the payment manager application running thereon) claims for Analytics and Pricing (done based on Contracts A and B). System 30 will also its claim tagging capabilities to tag the claims, e.g., by tagging as part of a bundled payment (BP), or as a fee-for-service claim (FFS). System 30 will then send tagged claims directly to TPA 20 on behalf of RBE 40 or provider 50. The system 30 may include a payment module that moves the funds from an account of RBE 40 to provider accounts based on the episode progress. Then, at Step 4, the payer 10 at block 216 and moves funds to pay the risk bearing entity 40, and/or the third-party administrator 20 at block 218 and moves funds to pay the risk bearing entity 40.

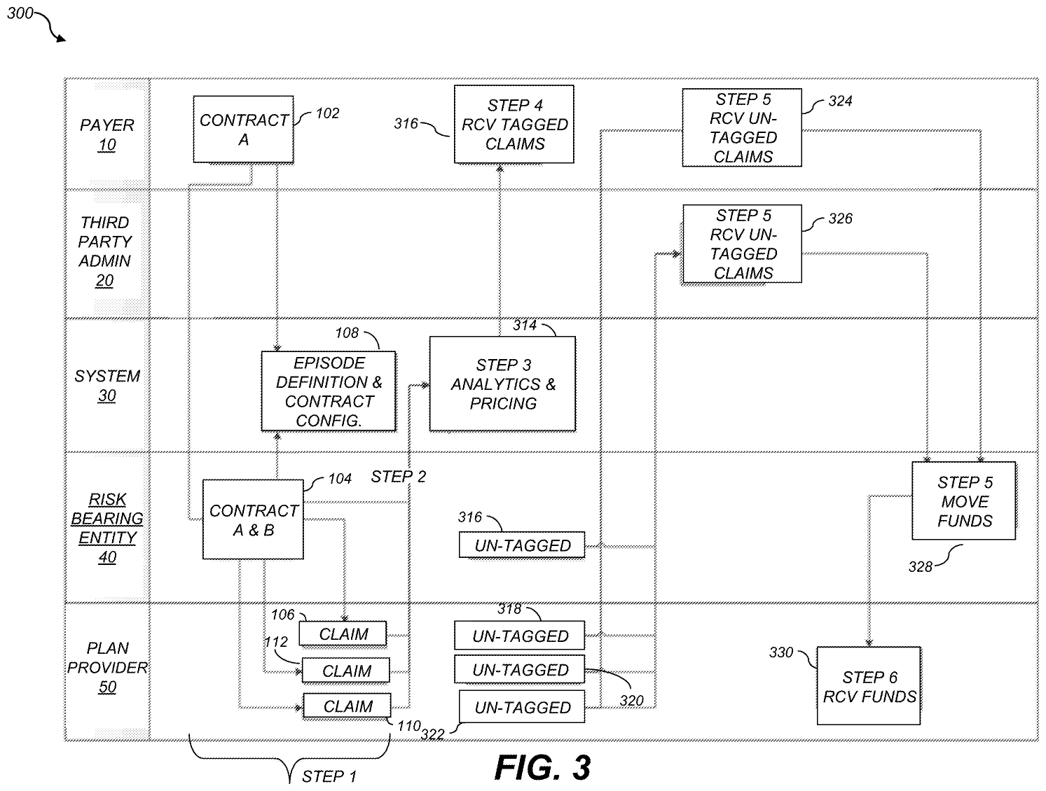

FIG. 3 is a flowchart depicting a method 300 of payments administration using smart contracts and distributed ledger technology, in accordance with one or more aspects of the present technique. The example of FIG. 3 differs from the prior examples in that entities send un-tagged claims to the payer 10 and TPA 20 at blocks 318-322. At block 314, system 30 receives, from the RBE 40 and provider 50, claims for Analytics and Pricing (done based on Contracts A and B). The system 30 at block 314 will use its claim tagging capabilities to tag the claims (BP or FFS) and send them to the payer 10 and TPA 20 at block 316. The system 30 will continued to make payments based on episode progress as defined by the smart contracts. The payer 10 at block 324 and the TPA 30 at block 326 receive the un-tagged claims, instruct the RBE 40 at block 328 to move funds if appropriate, and the provider receives funds at block 330.

Notably, this process will not disrupt the RBE-PP claim submission flow which occurs asynchronously with the receipt of the tagged claims.

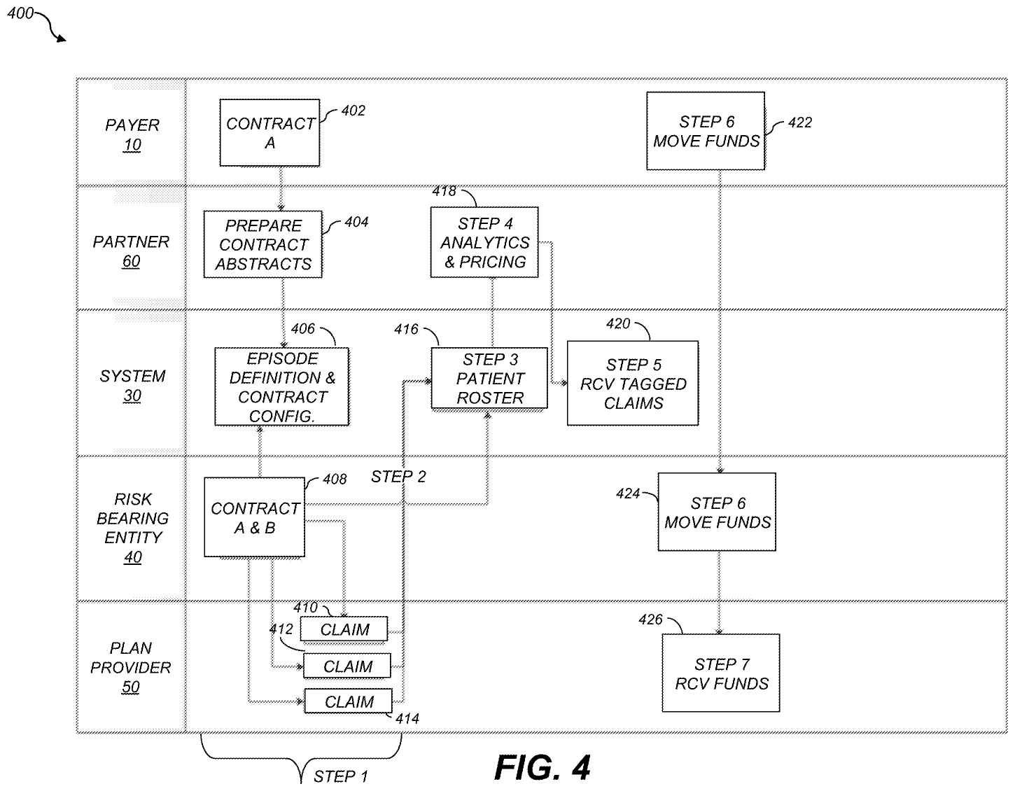

FIG. 4 is a flowchart depicting a method 400 of payments administration using smart contracts and distributed ledger technology, in accordance with one or more aspects of the present technique. FIG. 4 depicts an embodiment in which a partner entity 60 is used to offload the pricing/analytics and contract creation as well as the tagging functionality. Notably, this allows the system 30 to make use of a different partner entity depending on what episodes or claims are being processed, so that different partner entities can be used to impose different conditions for different business that are part of the ecosystem or marketplace of the present disclosure.

In the embodiment of FIG. 4, the payer 10 at block 402 engages with the partner 60 at block 404 for contract creation. The system 30 at block 406 defines the episodes and configures the contracts. The RBE 40 at block 408 engages in the contracts, and the provider submits claims at blocks 410-414. The system 30 at block 416 creates a patient roster for the episode and sends that to partner 60, which performs analytics and pricing at block 418, and tags the claims. The system 30 at block 420 then receives the tagged claims from the partner 60. Payments are made in accordance with the contracts with the payer 10 at block 422 moving funds to the risk bearing entity 40 at block 424, and the provider 50 at block 426 receiving funds in accordance with the progress of the episode as defined by the contracts.

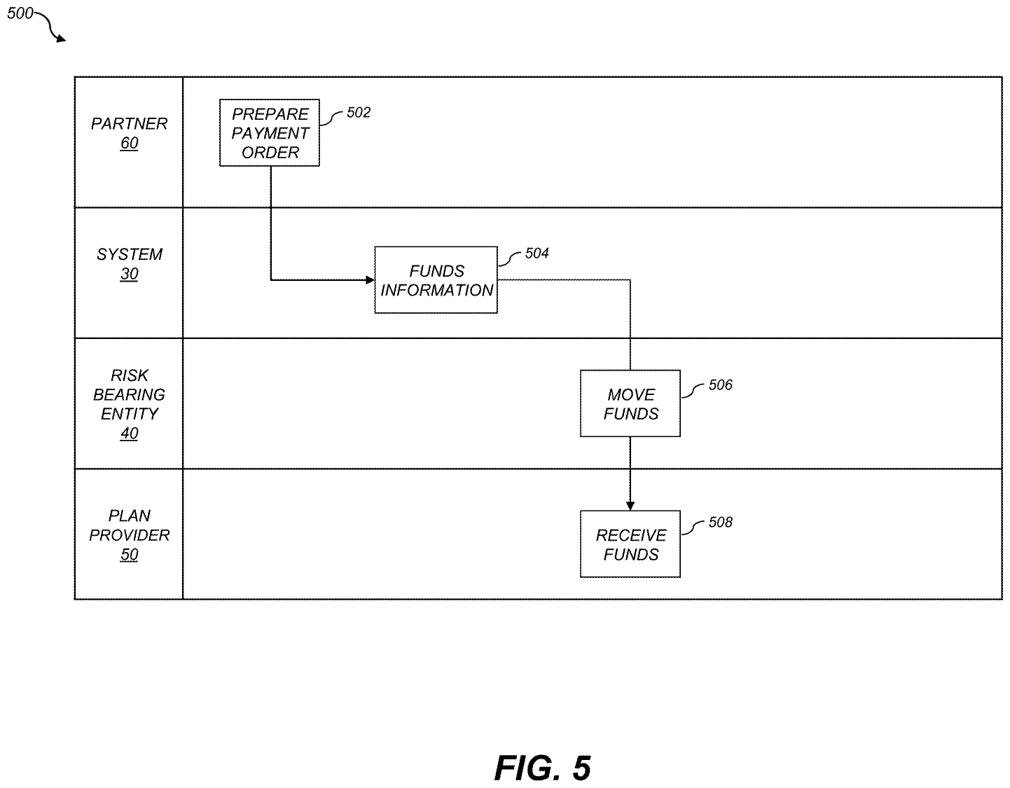

FIGS. 5 & 6 demonstrate that the partial functionality of the system can be used. FIG. 5 is a flowchart depicting a method 500 of payments administration using smart contracts and distributed ledger technology, in accordance with one or more aspects of the present technique. In the embodiment of FIG. 5, the system is used only for payments functionality by the partner. For example, the partner 60 at block 502 prepares a payment order. The system 30 at block 504 receives the funds information and determines to move funds at block 506 from the RBE 40. Then, the provider 50 at block 508 receives funds.

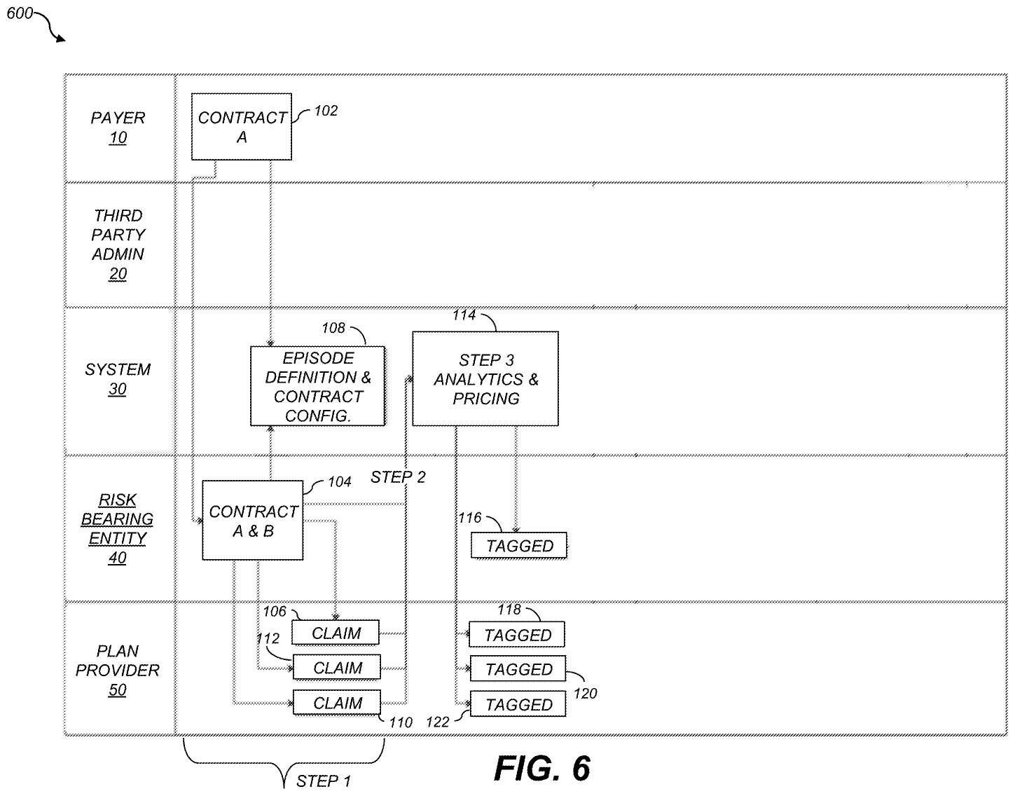

FIG. 6 is a flowchart depicting a method 600 of payments administration using smart contracts and distributed ledger technology, in accordance with one or more aspects of the present technique. In the example of FIG. 6, the solution is only used for claims tagging process. Step 1 includes configuration and definition of Smart Contracts A & B, as follows. The payer 10 at block 102 and the risk bearing entity 40 at block 104 establish Contract A. The risk bearing entity 40 at block 104 and plan provider 50 at block 106 establish Contract B. The system 30 at block 108 configures Contracts A & B and performs episode definition, including establishment of rules.

Step 2 includes claims being sent to the system 30 for analytics and pricing. For instance, the plan provider 50 submits claims relating to Contract B at blocks 106-110.

At Step 3, the system 30 at block 114 performs the analytics and pricing in accordance with Contracts A & B. For example, the system 30 creates a patient roster, analyzes and prices claims, and performs tagging of claims. The system 30 then uses claim tagging capabilities to tag the claims, for example, as Bundled Payment included (BP) or Fee For Service (FFS).

Continuing with the embodiment of FIG. 1, after the system 30 tags the claims, they are sent back to the entities, specifically to the risk bearing entity 40 at block 116 and the provider 50 at blocks 118-122.

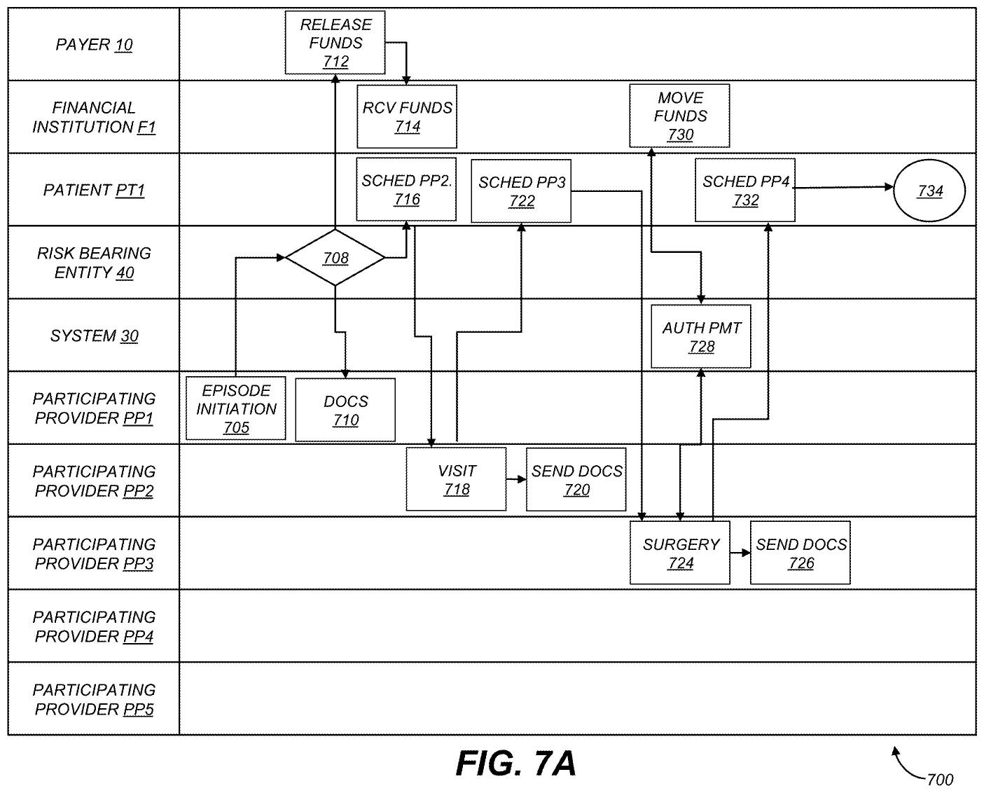

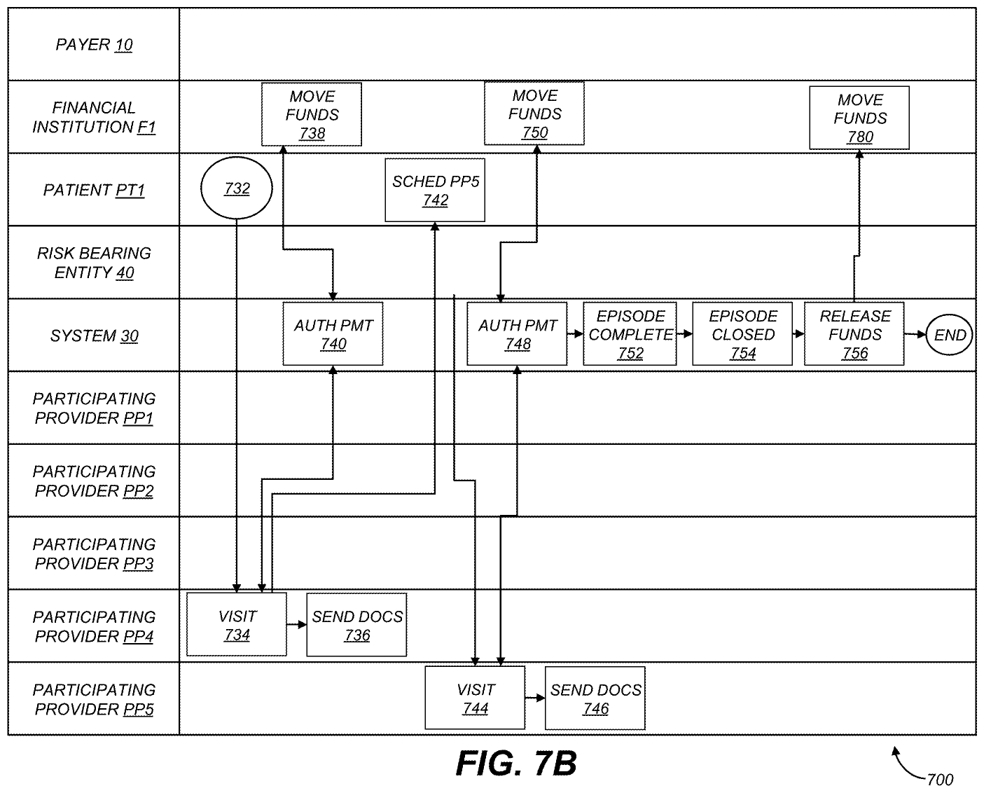

Next, a detailed working example involving multiple providers will be discussed by way of example, and not limitation. FIGS. 7A & 7B are flowcharts depicting a knee bundle example across multiple participants, in accordance with one or more aspects of the present technique. These flowcharts depict examples of private permissioned distributed ledger for bundled payment episodes. For example, a DLT implementation of bundled episodes can require one node per entity. These nodes can be hosted in the cloud infrastructure like Amazon Web Services (AWS) or Microsoft Azure or any other cloud provider. It can also be hosted on premise at the entity. For clients who cannot support a DLT node, the system of the present technique can host the node for them.

In different examples, different bundled episodes can be implemented for Knee, Shoulder, Hip surgeries or for maternity bundles, by way of example. The present technique applies to any value-based care scenario that makes use of the bundled episodes setup. The process flow diagrams of FIGS. 7A & 7B show how a knee bundle can be implemented across the different participants.

In the embodiment of FIGS. 7A-7B, the process starts at block 705. Next, system intercepts the 837 Claim File and scans the specific service lines to identify the Episode. Next, the provider PP1 submits Episodic Event to risk bearing entity 40 for approval at block 708. The risk bearing entity 40 validates the submitted Episodic Event and either Approves or Denies the Episode. For the purposes of this example, we shall assume that the Episode is approved, and smart contracts are created as discussed above.

Next, the system distributes Episode Event Documentation to all required Nodes, e.g., to the provider PP1 at block 710 (documents are also sent to the other entities.) Then payer 10 at block 712 approves release of Episode Funds to risk bearing entity 40 via financial institution (FI1) at block 714 and a notary function of system 30.

Next, the patient PT1 at block 716 schedules appointment for Knee Diagnosis with his/her Orthopedic Surgeon, provider PP2, and proceeds to the appointment. The patient PT1 completes the visit with Orthopedic provider PP2 at block 718 and proceeds to scheduling Surgery appointment at block 722. The system distribute Episode Documentation to all required Nodes at block 720. Next, the patient PT1 at block 722 schedules a surgery at the Surgery Center provider PP3, and proceeds to Surgery.

Next, at block 724, the patient PT1 goes through Surgery process. After surgery, in one example, the episode will specify that there is a wait period of 4 days to ensure there is no other complications from the surgery before proceeding to schedule Skilled Nursing Facility provider PP4 appointment.

Next, at block 726, the system distributes Episode Documentation to all required Nodes. After the mandatory wait period (typically 4 days) after Surgery, if there are no complications, the notary function of the system 30 authorizes release of funds at block 728 to approved entities deducting a pre-defined set percentage to be held as “withholding funds” at block 730. Then, at block 732, the patient (PT1) schedules Skilled Nursing Facility provider PP4 appointment and proceeds to appointment.

At block 734, the patient (PT1) completes Skilled Nursing Facility provider (PP4) appointment and proceeds to scheduling Physical Therapy provider PP5 appointment. At block 736, the system distributes Episode Documentation to all required Nodes. After the patient completes the Skilled Nursing Facility provider PP4 appointment, the notary function of the system authorizes release of payment funds at block 740 to Skilled Nursing Facility provider PP4 deducting a pre-defined set percentage to be held as “withholding funds” at block 738.

At block 742, the patient PT1 schedules Physical Therapy provider PP5 appointment(s) and proceeds to appointment. At block 744, the patient PT1 successfully completes all Physical Therapy provider PP5 appointment(s), this is typically 30 days or more and constitutes multiple appointments. Again, the episode definition and smart contract can specify this time period so that payments are only made after the required time period. At block 746, the system distributes Episode Documentation to all required Nodes.

After the patient completes the Physical Therapy provider PP5 Appointment(s), the notary function of the system 30 at block 748 authorizes release of payment funds to Physical Therapy Facility provider PP5 deducting a pre-defined set percentage to be held as “withholding funds” at block 750.

After the successful completion of Physical Therapy provider PP5 appointment(s), the Episode moves to “Episode Complete Status” at block 752. Then, 60 Days after Episode Complete Status, the Episode moves to “Episode Closed Status” at block 754. As Soon as Episode moves to “Episode Closed Status” (90), the notary function of the system 30 at block 756 initiates release of “withholding funds”. All withholding payments are distributed to providers PP1, PP2, PP3, PP4 and PP5.

The detailed working example of FIGS. 7A & 7B shows that the smart contracts and episode definition carried out by the system of the present disclosure can account for Episodes that include numerous different providers. The specific example related to Knee Surgery and Recovery, but one can readily understand that many composite, or multi-part episodes exist in the medical field. Each step can be defined in terms of the preconditions, post conditions, timing, success factors, etc. Payment can be released in part, in whole, after any or all of the conditions are met in accordance with the smart contracts.

As an advantage of the disclosed system, an ecosystem or marketplace of providers can agree to be bound to specific details in the form of smart contracts. Since the smart contracts are immutable and self-executing, many different variations can be hosted by the same system, allowing for greater flexibility in how medical payment administration for bundled episodes can be handled. Thus, the overall filed of bundled payments has been improved through this practical application.

The practical challenges addressed by the present technique are now discussed. First, the Project of design, development and implementation of a single Smart Contract becomes a very big project that needs to be coordinated between Product Owners, Technical Project Managers, Development, Compliance and QA teams of multiple entities.

In addition, since more than 2 entities are involved, the Smart Contracts input/output states, the logic contained within the Smart Contract as well as approval process between SME/Business/Technical teams becomes a cumbersome task.

Furthermore, for a project like Bundle Payment Episodes, one can imagine that scaling a solution like this which relies on several Smart Contracts will make it a multi-year implementation project.

To overcome these challenges with a practical solution, the present technique provides a Smart Contract Library (SCL) along with the solution. All Smart Contracts contain prose as well as parameter values to handle the logic of the transaction. The parameter values can be adjusted based on a complex rule-based engine logic that has the inherent business logic built into it. Key features of this solution include:

Pre-built templates that cover a majority of the scenarios.

End users can review the Smart Contract definition both in business terms as well as look at the pseudo code of the Smart Contract in the form of a JSON/XML.

Easy navigation and filtering capabilities allow for narrowing down the template that one wants to start with.

Allows end users to edit the templates and create their own version.

These versions then enter into a task workflow process for review and approval.

Workflow allows for co-ordination between users of the same or different entities.

Review and approval process is also tracked on the ledger and is made immutable.

Post the review and approval from all parties that have a say in that transaction—the Smart Contract is finalized with the signatures.

Existing Smart Contracts can be modified—it does not update the existing logic—it creates a new workflow with tasks to approve the newer version of the Smart Contract.

The templates that are provided as part of the SCL allow it to be a plug-and-play approach with just different parameter values.

The above approach allows for solving the massive problem of scaling the design, development, co-ordination, approval and deployment of Smart Contracts in a Distributed Ledger Implementation.

In order to provide further detail of the smart contracts supported by the system, certain embodiments of smart contract definitions are set forth below in Table 1 by way of example only, and not to limit the scope of the present disclosure in any way.

TABLE 1
Smart Contract Definitions

| 1. | | | [Smart Contract 1 - SC1] |
|---|---|---|---|
| | a. | | Definition: Transmit patient related Episode Event information to |
| | | RBE for approval. | |
| | b. | | Transactions: |

| | |
|---|---|
| i. | Tx: 1 |

| 1. | Participating Nodes: (ONode: PP1, Receiving Node: |
|---|---|
| | RBE1) |
| 2. | Shared Facts: |

a. Patient Demographics
b. Inclusion Diagnostics
c. Episode ID
d. Potential Event ID
e. Payer
f. “RBE<−>Payer” Contract Information
g. Clinical Data (CCD)

| | |
|---|---|
| 3. | Input & Output States: |

a. Input:

i. Data: Shared Facts
ii. Status Code: 5

b. Output:

i. Data: Approved/Denied
ii. Status Code: Approved (10)/Denied (99)

| 2. | | | [Smart Contract 2 - SC2] |
|---|---|---|---|
| | a. | | Definition: Broadcast Episode Event Status Information to |
| | | specified Node(s) | |
| | b. | | Transactions: |

| | |
|---|---|
| i. | Tx: 2 |

| 1. | Participating Nodes: (ONode: RBE1, Receiving Node: All- |
|---|---|
| | FI1,PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 10

b. Output:

i. Data: Approved
ii. Status Code: Approved (10)

| | |
|---|---|
| ii. | Tx: 5 |

| 1. | Participating Nodes: (ONode: PP2, Receiving Node: All- |
|---|---|
| | FI1, PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 20

b. Output:

i. Data: Visit Completion
ii. Status Code: Visit Complete (25)

| | |
|---|---|
| iii. | Tx: 8 |

| 1. | Participating Nodes: (ONode: PP3, Receiving Node: All- |
|---|---|
| | FI1, PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 35

b. Output:

i. Data: Visit Completion
ii. Status Code: Visit Complete (40)

| | |
|---|---|
| iv. | Tx: 12 |

| 1. | Participating Nodes: (ONode: PP4, Receiving Node: All- |
|---|---|
| | FI1, PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 65

b. Output:

i. Data: Visit Completion
ii. Status Code: Visit Complete (70)

| | |
|---|---|
| v. | Tx: 16 |

| 1. | Participating Nodes: (ONode: PP5, Receiving Node: All- |
|---|---|
| | FI1, PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 85

b. Output:

i. Data: Visit Completion
ii. Status Code: Visit Complete (86)

| | |
|---|---|
| vi. | Tx: 19 |

| 1. | Participating Nodes: (ONode: NTRY1, Receiving Node: |
|---|---|
| | All-PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 88

b. Output:

i. Data: Episode Completion Status
ii. Status Code: Episode Complete Status (89)

| | |
|---|---|
| vii. | Tx: 20 |

| 1. | Participating Nodes: (ONode: NTRY1, Receiving Node: |
|---|---|
| | All-PY1) |
| 2. | Shared Facts: |

a. Episode ID
b. Event ID
c. Status
d. Date and Time

| | |
|---|---|
| 3. | Input & Output States: |

a. Input:

i. Data: Shared Facts
ii. Status Code: 89

b. Output:

i. Data: Episode Closed Status
ii. Status Code: Episode Closed Status (90)

| 3. | | [Smart Contract 3 - SC3] |
|---|---|---|
| | a. | Definition: Request for scheduling Appointment |
| | b. | Transactions: |

| | |
|---|---|
| i. | Tx: 4 |

| | |
|---|---|
| 1. | Participating Nodes: (ONode:PT1, Receiving Node: PP2) |
| 2. | Shared Facts: |

a. Episode ID
b. Event ID
c. Status
d. Date and Time
e. Appt Req Dt & Time
f. Provider NPI

| | |
|---|---|
| 3. | Input & Output States: |

a. Input:

i. Data: Shared Facts
ii. Status Code: 15

b. Output:

i. Data: Approved
ii. Status Code: Appointment Approved (20)

| | |
|---|---|
| ii. | Tx: 7 |

| | |
|---|---|
| 1. | Participating Nodes: (ONode: PT1, Receiving Node: PP3) |
| 2. | Shared Facts: |

a. Episode ID
b. Event ID
c. Status
d. Date and Time
e. Appt Req Dt & Time
f. Provider NPI

| | |
|---|---|
| 3. | Input & Output States: |

a. Input:

i. Data: Shared Facts
ii. Status Code: 30

b. Output:

i. Data: Approved
ii. Status Code: Appointment Approved (35)

| | |
|---|---|
| iii. | Tx: 11 |

| | |
|---|---|
| 1. | Participating Nodes: (ONode: PT1, Receiving Node: PP4) |
| 2. | Shared Facts: |

a. Episode ID
b. Event ID
c. Status
d. Date and Time
e. Appt Req Dt & Time
f. Provider NPI

| | |
|---|---|
| 3. | Input & Output States: |

a. Input:

i. Data: Shared Facts
ii. Status Code: 60

b. Output:

i. Data: Approved
ii. Status Code: Appointment Approved (65)

| | |
|---|---|
| iv. | Tx: 15 |

| | |
|---|---|
| 1. | Participating Nodes: (ONode: PT1, Receiving Node: PP5) |
| 2. | Shared Facts: |

a. Episode ID
b. Event ID
c. Status
d. Date and Time
e. Appt Req Dt & Time
f. Provider NPI

| | |
|---|---|
| 3. | Input & Output States: |

a. Input:

i. Data: Shared Facts
ii. Status Code: 80

b. Output:

i. Data: Approved
ii. Status Code: Appointment Approved (85)

| 4. | | | [Smart Contract 4 - SC4] |
|---|---|---|---|
| | a. | | Definition: Transmit Episode Event Patient centric data to |
| | | authorized Node(s) | |
| | b. | | Transactions: |

| | |
|---|---|
| i. | Tx: 3 |

| 1. | Participating Nodes: (ONode: RBE1, Receiving Node: |
|---|---|
| | PT1, PP1, PP2) |
| 2. | Shared Facts: |

a. Episode ID
b. Event ID
c. Status
d. Date and Time
e. Clinical Data (CCD)

| | |
|---|---|
| 3. | Input & Output States: |

a. Input:

i. Data: Shared Facts
ii. Status Code: 10

b. Output:

i. Data: Diagnosis Data
ii. Status Code: Diagnosis Received (15)

| | |
|---|---|
| ii. | Tx: 6 |

| 1. | Participating Nodes: (ONode: PP2, Receiving Node: RBE1, |
|---|---|
| | PT1, PP1, PP3) |
| 2. | Shared Facts: |

a. Episode ID
b. Event ID
c. Status
d. Date and Time
e. Clinical Data (CCD)

| | |
|---|---|
| 3. | Input & Output States: |

a. Input:

i. Data: Shared Facts
ii. Status Code: 25

b. Output:

i. Data: Diagnosis Data
ii. Status Code: Diagnosis Received (30)

| | |
|---|---|
| iii. | Tx: 9 |

| 1. | Participating Nodes: (ONode: PP3, Receiving Node: RBE1, |
|---|---|
| | PT1, PP1, PP2, PP4) |
| 2. | Shared Facts: |

a. Episode ID
b. Event ID
c. Status
d. Date and Time
e. Clinical Data (CCD)

| | |
|---|---|
| 3. | Input & Output States: |

a. Input:

i. Data: Shared Facts
ii. Status Code: 40

b. Output:

i. Data: Diagnosis Data
ii. Status Code: Diagnosis Received (45)

| | |
|---|---|
| iv. | Tx: 13 |

| 1. | Participating Nodes: (ONode: PP4, Receiving Node: RBE1, |
|---|---|
| | PT1, PP1, PP2, PP5) |
| 2. | Shared Facts: |

a. Episode ID
b. Event ID
c. Status
d. Date and Time
e. Clinical Data (CCD)

| | |
|---|---|
| 3. | Input & Output States: |

a. Input:

i. Data: Shared Facts
ii. Status Code: 70

b. Output:

i. Data: Diagnosis Data
ii. Status Code: Diagnosis Received (75)

| | |
|---|---|
| v. | Tx: 17 |

| 1. | Participating Nodes: (ONode: PP5, Receiving Node: RBE1, |
|---|---|
| | PT1, PP1, PP2) |
| 2. | Shared Facts: |

a. Episode ID
b. Event ID
c. Status
d. Date and Time
e. Clinical Data (CCD)

| | |
|---|---|
| 3. | Input & Output States: |

a. Input:

i. Data: Shared Facts
ii. Status Code: 86

b. Output:

i. Data: Diagnosis Data
ii. Status Code: Diagnosis Received (87)

| 5. | | | [Smart Contract 5 - SC5] |
|---|---|---|---|
| | a. | | Definition: HSBlox Notary provides transaction authorization and |
| | | triggers payment transfer between Node(s) and Financial Institution(s). | |
| | b. | | Transactions: |

| | |
|---|---|
| i. | Tx: 10 (a, b and c) |

| | |
|---|---|
| 1. | Participating Nodes: (ONode: NTRY1, |

a. Funds Source: RBE1; Receiving Node: PP1

i. (FI1 holds the accounts)

b. Funds Source: RBE1; Receiving Node: PP2

i. (FI1 holds the accounts)

c. Funds Source: RBE1; Receiving Node: PP3

i. (FI1 holds the accounts)

| | |
|---|---|
| 2. | Shared Facts: |

a. Episode ID
b. Event ID
c. Status
d. Date and Time
e. Account ID
f. Payment Amount
g. Withhold Amount

| | |
|---|---|
| 3. | Input & Output States: |

a. Tx: 10a - PP1 Payment post-Surgery

i. Input:

| | |
|---|---|
| 1. | Data: Shared Facts |
| 2. | Status Code: 45 |

ii. Output:

| | |
|---|---|
| 1. | Data: Payment Data |
| 2. | Status Code: Payment Disbursed |

(50)

b. Tx: 10b - PP2 Payment post-Surgery

i. Input:

| | |
|---|---|
| 1. | Data: Shared Facts |
| 2. | Status Code: 50 |

ii. Output:

| | |
|---|---|
| 1. | Data: Payment Data |
| 2. | Status Code: Payment Disbursed |

(55)

c. Tx: 10c - PP3 Payment post-Surgery

i. Input:

| | |
|---|---|
| 1. | Data: Shared Facts |
| 2. | Status Code: 55 |

ii. Output:

| | |
|---|---|
| 1. | Data: Payment Data |
| 2. | Status Code: Payment Disbursed |

(60)

| | |
|---|---|
| ii. | Tx: 14 |

| | |
|---|---|
| 1. | Participating Nodes: (ONode: NTRY1, |

a. Funds Source: RBE1; Receiving Node: PP4

i. (FI1 holds the accounts)

| | |
|---|---|
| 2. | Shared Facts: |

a. Episode ID
b. Event ID
c. Status
d. Date and Time
e. Account ID
f. Payment Amount
g. Withhold Amount

| | |
|---|---|
| 3. | Input & Output States: |

a. Payment for-Skilled Nursing Facility (PP4)

i. Input:

| | |
|---|---|
| 1. | Data: Shared Facts |
| 2. | Status Code: 75 |

ii. Output:

| | |
|---|---|
| 1. | Data: Payment Data |
| 2. | Status Code: Payment Disbursed |

(80)

| | |
|---|---|
| iii. | Tx: 18 |

| | |
|---|---|
| 1. | Participating Nodes: (ONode: NTRY1, |

a. Funds Source: RBE1; Receiving Node: PP5

i. (FI1 holds the accounts)

| | |
|---|---|
| 2. | Shared Facts: |

a. Episode ID
b. Event ID
c. Status
d. Date and Time
e. Account ID
f. Payment Amount
g. Withhold Amount

| | |
|---|---|
| 3. | Input & Output States: |

a. Payment for-Physical Therapy Facility (PP5)

i. Input:

| | |
|---|---|
| 1. | Data: Shared Facts |
| 2. | Status Code: 87 |

ii. Output:

| | |
|---|---|
| 1. | Data: Payment Data |
| 2. | Status Code: Payment Disbursed |

(88)

| | |
|---|---|
| iv. | Tx: 21 (a, b, c, d and e) |

| | |
|---|---|
| 1. | Participating Nodes: (ONode: NTRY1, |

a. Funds Source: RBE1; Receiving Node: PP1

i. (FI1 holds the accounts)

b. Funds Source: RBE1; Receiving Node: PP2

i. (FI1 holds the accounts)

c. Funds Source: RBE1; Receiving Node: PP3

i. (FI1 holds the accounts)

d. Funds Source: RBE1; Receiving Node: PP4

i. (FI1 holds the accounts)

e. Funds Source: RBE1; Receiving Node: PP5

i. (FI1 holds the accounts)

| | |
|---|---|
| 2. | Shared Facts: |

a. Episode ID
b. Event ID
c. Status
d. Date and Time
e. Account ID
f. Payment Amount
g. Withhold Amount

| | |
|---|---|
| 3. | Input & Output States: |

a. Tx: 21a - PP1 Final Payment (withheld amount)

i. Input:

| | |
|---|---|
| 1. | Data: Shared Facts |
| 2. | Status Code: 90 |

ii. Output:

| | |
|---|---|
| 1. | Data: Payment Data |
| 2. | Status Code: Withheld Amount |

Disbursed (91)

b. Tx: 21b - PP2 Final Payment (withheld amount)

i. Input:

| | |
|---|---|
| 1. | Data: Shared Facts |
| 2. | Status Code: 91 |

ii. Output:

| | |
|---|---|
| 1. | Data: Payment Data |
| 2. | Status Code: Withheld Amount |

Disbursed (92)

c. Tx: 21c - PP3 Final Payment (withheld amount)

i. Input:

| | |
|---|---|
| 1. | Data: Shared Facts |
| 2. | Status Code: 92 |

ii. Output:

| | |
|---|---|
| 1. | Data: Payment Data |
| 2. | Status Code: Withheld Amount |

Disbursed (93)

d. Tx: 21d - PP4 Final Payment (withheld amount)

i. Input:

| | |
|---|---|
| 1. | Data: Shared Facts |
| 2. | Status Code: 93 |

ii. Output:

| | |
|---|---|
| 1. | Data: Payment Data |
| 2. | Status Code: Withheld Amount |

Disbursed (94)

e. Tx: 21e - PP5 Final Payment (withheld amount)

i. Input:

| | |
|---|---|
| 1. | Data: Shared Facts |
| 2. | Status Code: 94 |

ii. Output:

| | |
|---|---|
| 1. | Data: Payment Data |
| 2. | Status Code: Withheld Amount |

Disbursed (95)

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. A payment administration system for administering payments related to a bundled treatment episode involving multiple providers, the system comprising:
a first provider entity for providing at least a first step of the bundled treatment episode;
a second provider entity for providing at least a second step of the bundled treatment episode;
a risk bearing entity for approving the bundled treatment episode, wherein the first and second provider entities and the risk bearing entity enter into one or more smart contracts related to payments for the bundled treatment episode;
a distributed ledger for enforcing the one or more smart contracts; and
a payment manager application using the distributed ledger technology, wherein each of the first and second provider entities send claims to the payment manager application, and the payment manager application tags the claims as being part of the bundled treatment episode and approves the claims in accordance with the smart contracts.

2. The system of claim 1, wherein a payer entity receives the tagged claims from the payment manager and makes payments to the first and second provider entities based on the tagged claims.

3. The system of claim 1, wherein a third party administrator entity receives the tagged claims from the payment manager and facilitates a paying entity making payments to the first and second provider entities.

4. The system of claim 1, wherein the payment manager application tags some claims and does not tag other claims, and the tagged claims are sent to a first entity and the untagged claims are sent to a second entity.

5. The system of claim 1, wherein the payment manager application offloads processing logic to a partner entity, and the partner entity performs analytics and pricing of the one or more smart contracts.

6. The system of claim 1, wherein the payment manager application receives a plurality of claims from a plurality of entities related to a plurality of bundled treatment episodes covered by a plurality of smart contracts, and the payment manager application provides claims processing for the plurality of claims.

7. The system of claim 1, further comprising a third provider entity participating the bundled treatment episode and the one or more smart contracts, wherein the third provider entity initiates the bundled treatment episode.

8. The system of claim 1, further comprising a payer entity, the payer entity participating the bundled treatment episode and the one or more smart contracts, wherein the payment manager sends tagged claims to the payer entity.

9. The system of claim 8, wherein the first and second provider entities send untagged claims to the payer entity and the payer entity determines payments based on the tagged claims received from the payment manager and the untagged claims received from the first and second provider entities.

10. A payment administration method for administering payments related to a bundled treatment episode involving multiple providers, the method comprising:
initiating a bundled treatment episode;
approving the bundled treatment episode;
establishing one or more smart contracts related to payments for the bundled treatment episode;
providing at least a first step of the bundled treatment episode;
providing at least a second step of the bundled treatment episode;
sending claims related to the first and second steps;
tagging the claims as being part of the bundled treatment episode;
approving the claims in accordance with the smart contracts.

11. The method of claim 10, further comprising receiving the tagged claims.

12. The method of claim 10, further comprising making payments to providers of the first and second steps based on the tagged claims.

13. The method of claim 10, further comprising tagging some claims and not tagging other claims.

14. The method of claim 10, further comprising offloading processing logic for analytics and pricing of the one or more smart contracts.

15. The method of claim 10, further comprising receiving a plurality of claims related to a plurality of bundled treatment episodes covered by a plurality of smart contracts, and tagging the plurality of claims.

16. The method of claim 10, further comprising initiating the bundled treatment episode.

17. The method of claim 10, further comprising determining payments based on a specific tagged claim.
